(19) United States
(12) Patent Application Publication
(10) Pub. No.: US 2013/0291417 A1
(43) Pub. Date: Nov. 7, 2013

(54) PEELABLE LABEL AND METHOD OF USING SAME

(71) Applicant: PRESTONE PRODUCTS CORPORATION, Danbury, CT (US)

(72) Inventors: Aylin Candan Erenguc, Chicago, IL (US); Charles Ryan Veers, Chicago, IL (US)

(21) Appl. No.: 13/874,780

(22) Filed: May 1, 2013

Related U.S. Application Data
(60) Provisional application No. 61/641,621, filed on May 2, 2012.
(60) Provisional application No. 61/768,148, filed on Feb. 22, 2013.

(51) Int. Cl. G09F 3/00; G09F 3/10

(52) U.S. Cl. CPC G09F 3/0288; G09F 3/10
USPC 40/638; 40/675

(57) ABSTRACT

A peelable label for a container includes a fixed label and a removable label removably attached to at least a portion of the fixed label. A first securement feature is formed along a first side of the removable label and a second securement feature is formed along a second side of the removable label opposite the first side. The first and second securement features cooperate to retain the removable label in a shape of a frustoconical funnel.

### CROSS REFERENCE TO RELATED APPLICATIONS

This application claims the benefit of U.S. Provisional Application No. 61/641,621, filed on May 2, 2012, and U.S. Provisional Application No. 61/768,148, filed Feb. 22, 2013, both incorporated by reference herein.

### BACKGROUND

The present invention relates generally to a peelable label and, more particularly, to a peelable label and method of using the peelable label.

### SUMMARY

In illustrative embodiments, a peelable label for a container includes a fixed label and a removable label removably attached to at least a portion of the fixed label. A first securement feature is formed along a first side of the removable label and a second securement feature is formed along a second side of the removable label opposite the first side. The first and second securement features cooperate to retain the removable label in a shape of a frustoconical funnel.

In illustrative embodiments, a method of using a peelable label including a fixed label disposed on a container and a removable label removably attached to at least a portion of the fixed label includes the steps of removing at least a portion of the removable label from at least a portion of the fixed label and manipulating the removable label to form a funnel. The method further includes the step of securing a first side of the removable label to a second side of the removable label opposite the first side to connect the first and second sides and retain the removable label in the form of the funnel.

According to yet further illustrative embodiments, a peelable label for a container includes a fixed label and a removable label. The removable label including a retained portion that remains attached to the fixed label and a removable portion that is removable from the fixed label. The removable portion of the removable label includes first and second opposing and generally parallel side edges and a third side edge extending between the first and second side edges. At least a portion of the third side edge includes a semi-circular shape that, when the removable portion is formed into a shape of a funnel, forms an exit of the funnel. The removable portion also includes a fourth side edge extending between the first and second side edges opposite the third side edge.

According to further illustrative embodiments, a label assembly for a container comprises a fixed label having a first side and a second side, the first side adapted to be secured the to the container. A removable label is positioned to overlay at least a portion of the fixed label, the removable label having a removable portion and a retained portion, the retained portion adapted to be secured to the second side of the fixed label and the removable portion is adapted to be secured to the retained portion, the removable portion formed to include a slot. Pulling the removable portion away from the fixed label causes separation of the removable portion from the fixed label and the retained portion. The removable portion includes a tab that can be inserted into the slot upon manipulating the removable label portion into a frustoconical shape.

### BRIEF DESCRIPTION OF THE DRAWINGS

FIG. 1 is a front elevational view of a container;

FIG. 2 is a rear elevational view of the container of FIG. 1 depicting a first embodiment of a peelable label;

FIG. 3 is a rear elevational view of the container of FIG. 1 as the peelable label is removed from a rear wall of the container;

FIG. 4 is a rear elevational view of the container of FIG. 1 with the peelable label removed therefrom;

FIG. 5 is a perspective view of the peelable label after it has been removed from the container of FIG. 1;

FIG. 6 is a perspective view of the peelable label as it is rolled to form a funnel and further depicting a peelable strip that may be removed from an edge of the peelable label;

FIG. 7 is a perspective view of the peelable label after it has been rolled to fully form a funnel and after the peelable strip has been removed to expose sealing tape that seals an edge of the funnel to itself;

FIG. 8 is a front and side perspective view of a container including a second embodiment of a peelable label;

FIG. 9 is an exploded view of the container and peelable label of FIG. 8 with a portion of the peelable label removed from a remainder of the peelable label;

FIG. 10 is a top perspective view of the peelable label of FIG. 8 as it is rolled into a funnel;

FIG. 11 is a top perspective view of the peelable label of FIG. 8 after it has been rolled into a funnel and a tab of the peelable label is inserted into a slot for retaining the peelable label in the form of the funnel;

FIG. 12 is a top perspective view of another embodiment of a peelable label after it has been rolled into a funnel and a corner of the peelable label is inserted into a slot for retaining the peelable label in the form of the funnel; and

FIG. 13 is a top perspective view of a further embodiment of a peelable label as it is rolled into a funnel.

Other aspects and advantages of the present invention will become apparent upon consideration of the following detailed description, wherein similar structures have like or similar reference numerals.

### DETAILED DESCRIPTION

The present disclosure is directed to a peelable label assembly. While the present disclosure may be embodied in many different forms, one specific embodiment is discussed herein with the understanding that the present disclosure is to be considered only as an exemplification of the principles of the disclosure, and it is not intended to limit the disclosure to the embodiment illustrated.

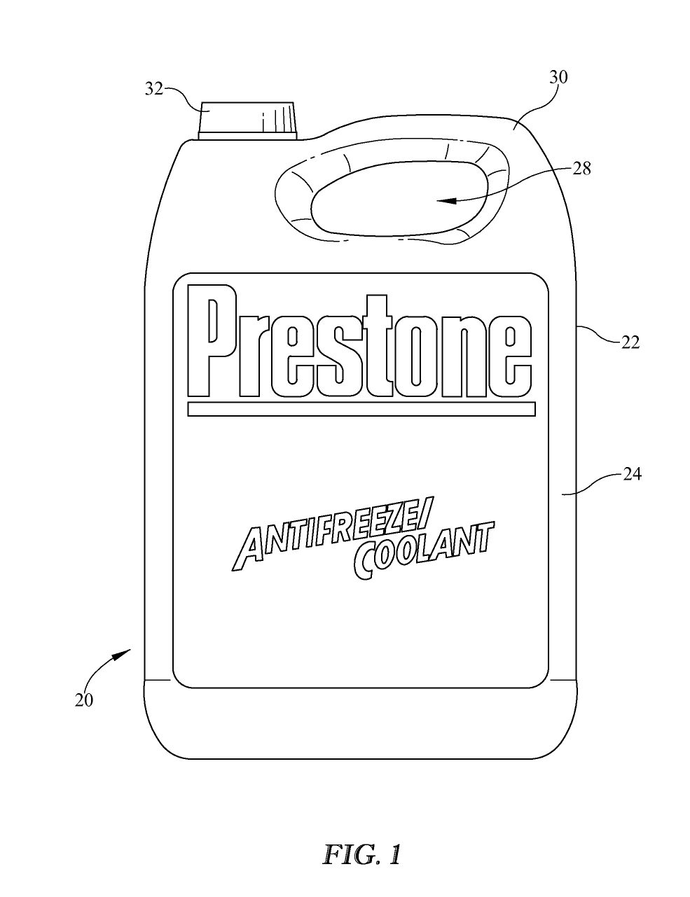

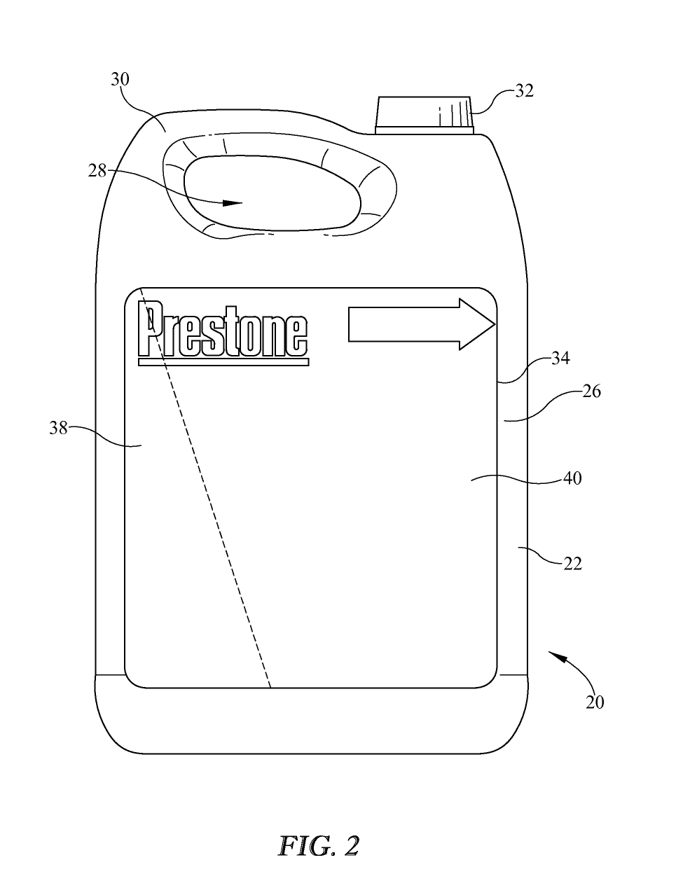

Referring to FIGS. 1 and 2, a container 20 is shown for holding a liquid or other flowable material that may be poured from the container. The liquid or flowable material may be a motor oil, an antifreeze, granular substances or any other flowable material that is held and/or sold within a container. The container 20 includes a body 22 having a front wall 24, a rear wall 26, a handle 28 disposed between the front and rear walls 24, 26 adjacent a top 30 of the container 20, and an opening (not shown) for pouring a liquid from the container 20. A cap 32 may be disposed over the opening to enclose the liquid within the container 20.

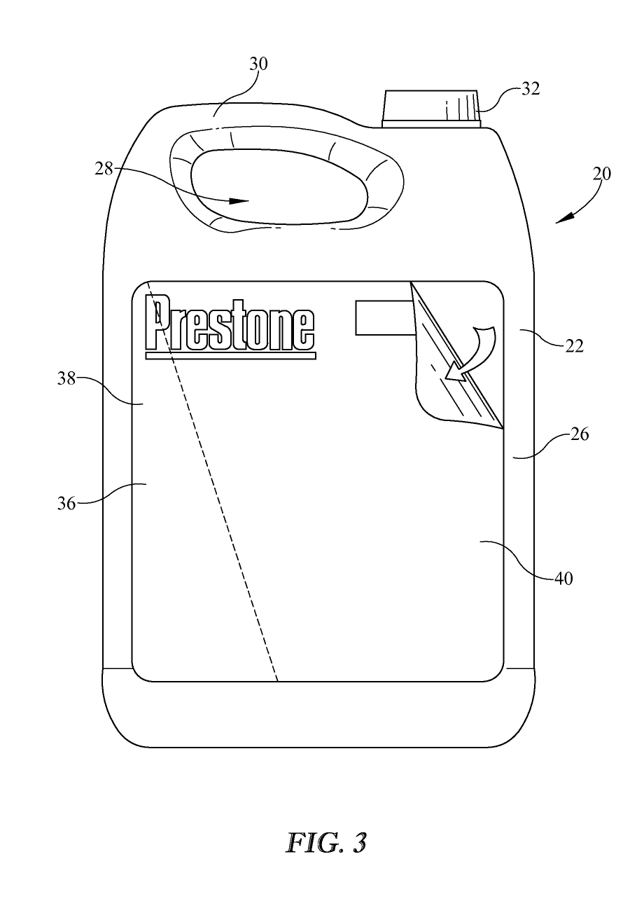

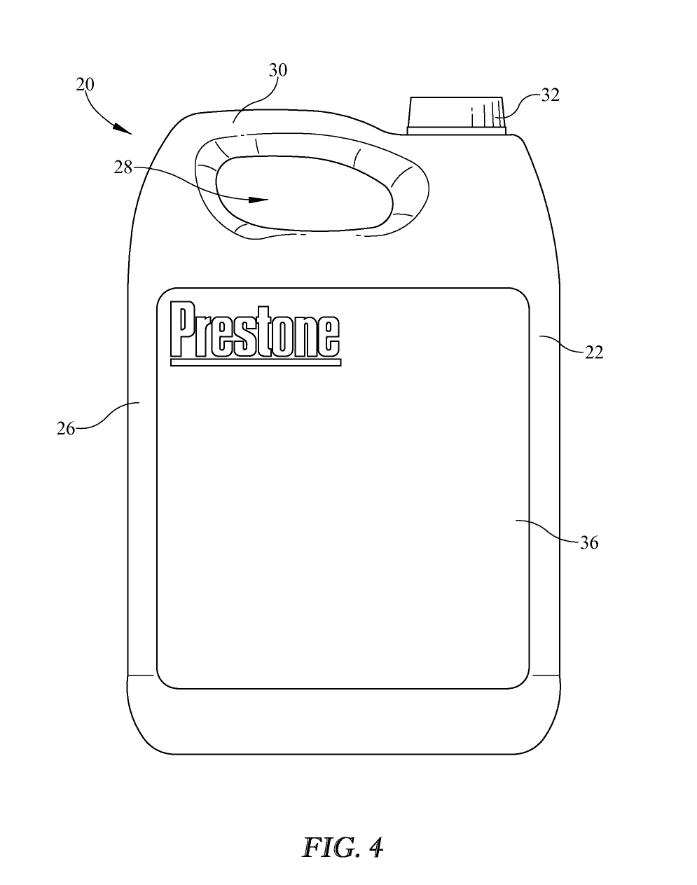

As seen in FIGS. 2 and 3, a peelable label 34 is disposed on the rear wall 26 of the container 20, but could alternatively be placed on any wall or area of the container 20. The peelable label 34 includes a fixed label 36 that remains on the rear wall 26 of the container 20 and a removable label 38 that is attached to the fixed label 36 during manufacture of the container 20 and removed from the fixed label 36 by a user (see FIGS. 3 and 4). Fixed label 36 is affixed to the container by use of an adhesive or other lamination process. At least a portion of removable label 38 is releasably secured to the fixed label 36 by use a low bond strength adhesive or pressure sensitive adhesive that permits removable label 38 to be peeled from fixed label 36. Removable label 38 includes an adhesive sealing tape 50 along edge 48 that is covered by release liner 46.

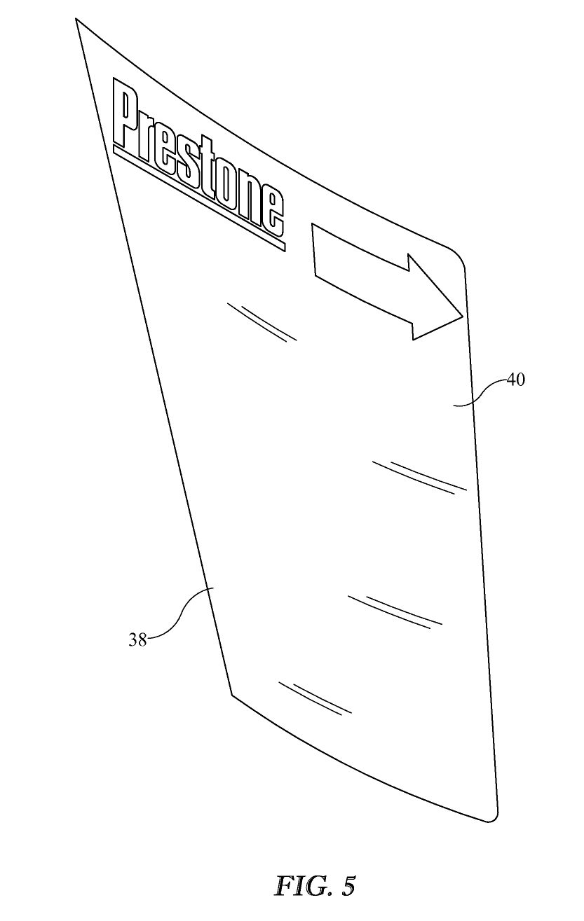

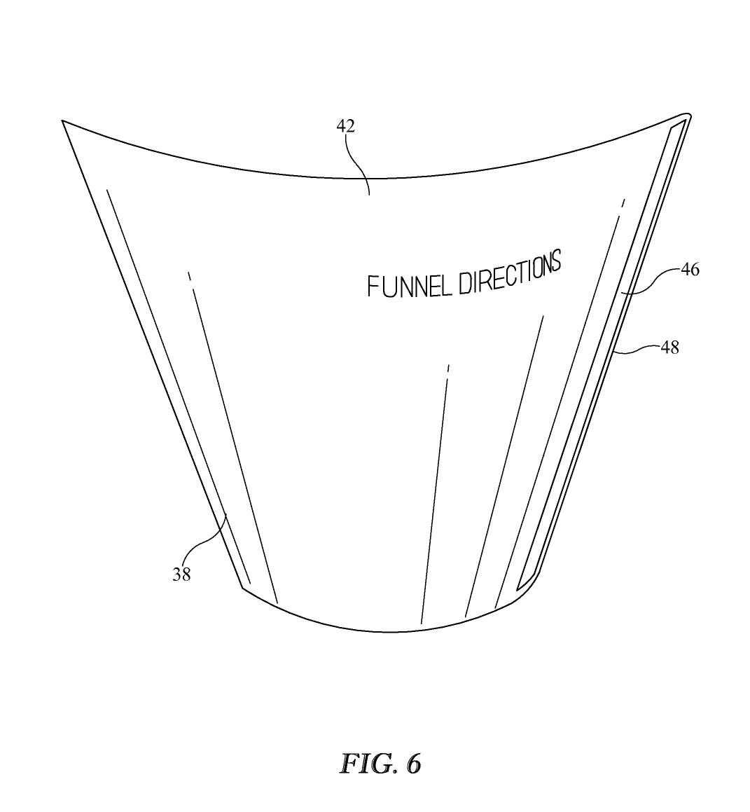

Once the removable label 38 has been removed from the fixed label 36, as seen in FIG. 5, a user positions the label so that a first surface 40 of the removable label 38 that faced outwardly when the removable label 38 was attached to the fixed label 36 faces away from the user's hand and a second surface 42 opposite the first surface 40 is in contact with the user's hand. The user thereafter rolls the removable label portion 38, as seen in FIG. 6, with the second surface 42 forming an outside of a frustoconically-shaped funnel 44.

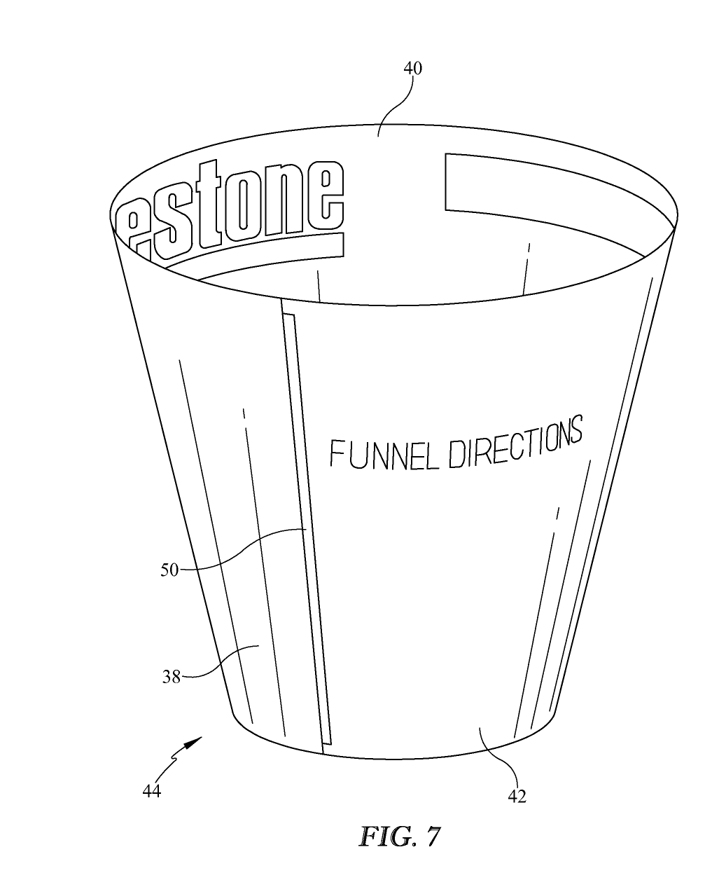

Once the funnel 44 has been formed in any manner desired by the user, release liner 46 disposed along an edge 48 of the removable label portion 38 on the second surface 42 is removed, exposing an adhesive sealing tape 50. The sealing tape 50 is attached to the second surface 42 of the removable label portion 38 to fully form the funnel 44 and prevent the funnel 44 from unrolling, as seen in FIG. 7. As seen in FIGS. 6 and 7, directions for forming the funnel 44 may be provided on the second surface 42 or any other surface of the label 34 or the container 20.

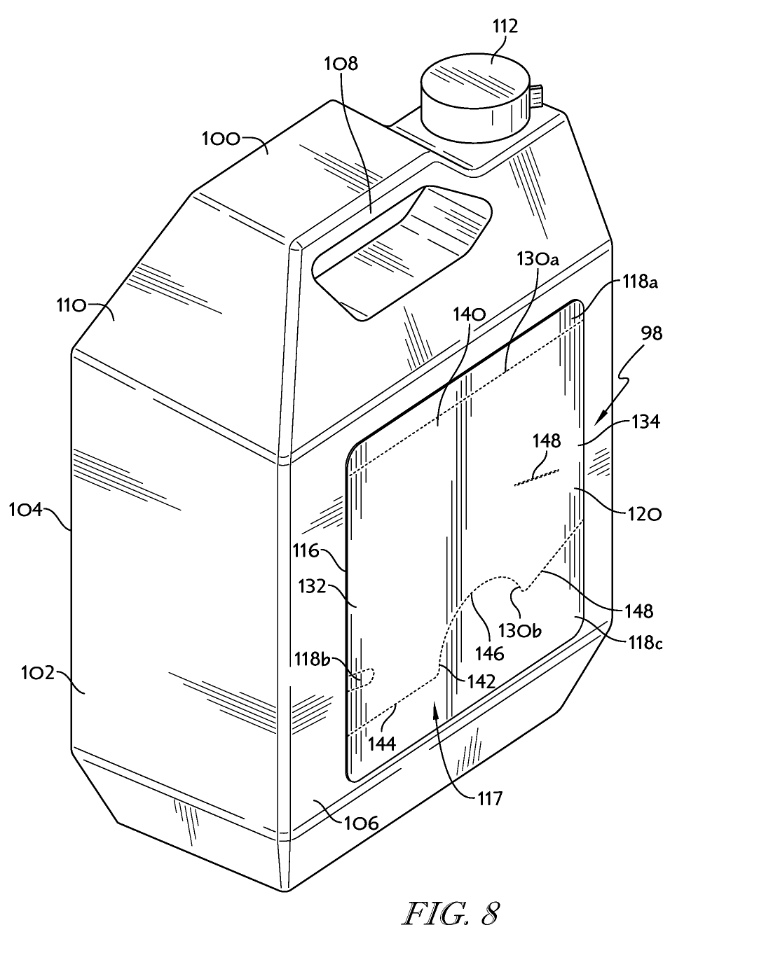

A second embodiment of a peelable label 98 on a container 100 is depicted in FIG. 8. The container 100 is shown for holding a liquid or other flowable material that may be poured from the container 100. The liquid or flowable material may be a motor oil, an antifreeze, a granular substance, or any other material that is held and/or sold within a container. The container 100 includes a body 102 having a front wall 104, a rear wall 106, a handle 108 disposed between the front and rear walls 104, 106 adjacent a top 110 of the container 100, and an opening (not shown) for pouring the liquid from the container 100. A cap 112 is disposed over the opening to enclose the liquid within the container 100.

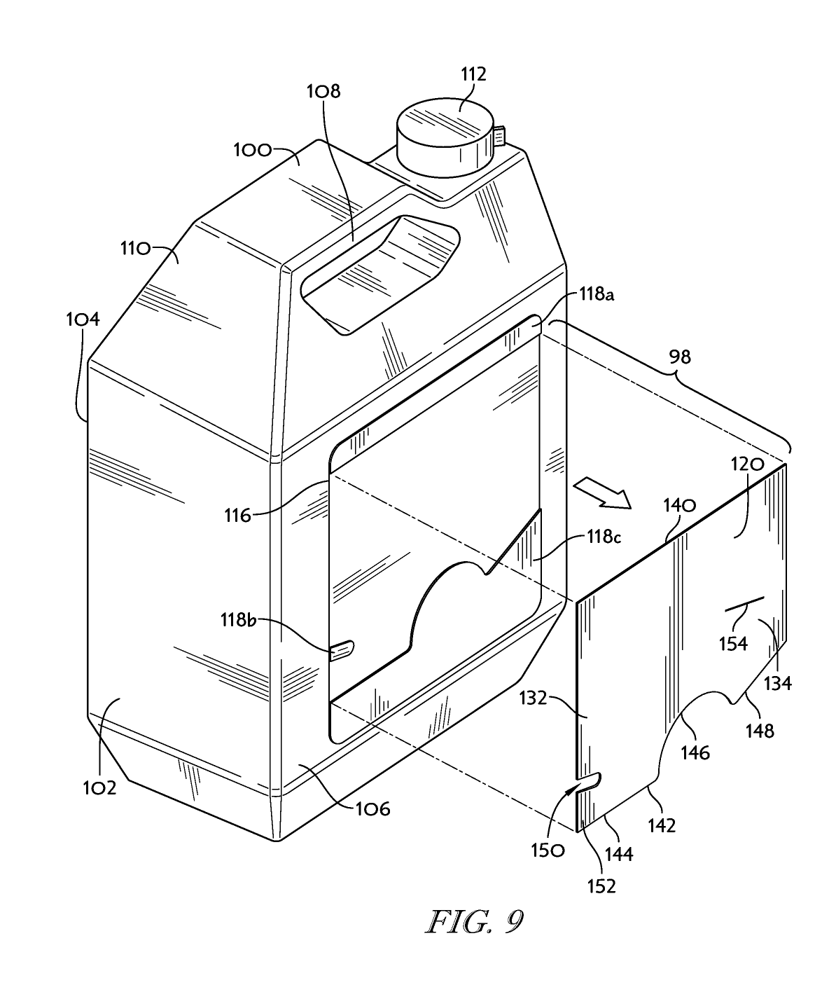

As seen in FIGS. 8 and 9, the peelable label 98 is disposed on the rear wall 106 of the container 100, but may alternatively be disposed on any wall or area of a container 100. The peelable label 98 includes a fixed label 116 that is secured to the rear wall 106 of the container 100 and a removable label 117 that includes at least a portion that is removably secured to the fixed label 116. Removable label 117 can be made from a polymer material or a coated paper that is water resistant. The removable label 117 includes retained label portions 118a-118c and a removable label portion 120. Retained label portions 118a-118c are adapted to remain attached to the fixed label portion 116 when the removable label portion 120 of the removable label 117 is removed from the fixed label 116 by a user, as shown, for example, in FIG. 9. Fixed label 116 is secured to the container 100 by adhesive or other lamination means.

Retained label portions 118a-118c can be secured to fixed label 116 by adhesive or other lamination means. Removable label portion 120 is secured to retained label portions 118a-118c by perforations 130a, 130b, as shown, for example, in FIG. 8. Removable label portion 120 alternatively can be secured to the fixed label 116 by use of a low bond or pressure sensitive adhesive. If a low bond adhesive is used in connection with the removable label portion 120, removable label portion 120 can be separated from one or more of the retained label portions 118-118c by die cutting.

The removable label portion 120 is removed from the fixed label 116 and the retained label portions 118a-118c by grasping a first side edge 132 or a second side edge 134 of the removable label portion 120 and pulling the removable label portion 120 toward the other of the first side edge 132 and the second side edge 134. As the removable label portion 120 is pulled, the removable label portion 120 is separated from the retained label portions 118a, 118b. The retained label portion 118c is also left behind on the fixed label 116 (with the fixed label portions 118a, 118b). Removable label portion 120 may also include written instructions to inform the user on how to convert the label portion 120 into a funnel 156. Removal of the removable label portion 120 exposes indicia formed on the second side of the fixed label 116. The removable portion 120 also includes indicia that is similar to the indicia formed on the second side of the fixed label 116.

Referring to FIGS. 8 and 9, the removable label portion 120 includes a top edge 140 that is generally linear and a bottom edge 142 that is non-linear and includes a first, generally linear segment 144, a second, semi-circular segment 146 extending from the first segment 144, and a third, diagonal segment 148 extending from the second segment 146. The semi-circular segment 146 is positioned between the linear and diagonal segments 144 and 148. In an illustrative embodiment and as seen in FIG. 9, the semi-circular segment 146 forms from about 20 percent to about 50 percent of the bottom edge 142. The removable label portion 120 further includes an angled perforation line 148 that forms a slot 154 when the perforation line is broken.

In an illustrative embodiment, the perforation line 142 is angled downwardly as it extends in a direction away from the first side edge 132 toward the second side edge 134. Further, after removal of the removable label portion 120 from the fixed label 116 and the retained label portions 118a-118c, the removable label portion 120 is formed to include a cutout 150 along first side edge 132 that forms a tab 152. Tab 152 is spaced from the bottom edge 142 of the removable label portion 120. In an illustrative embodiment, the tab 152 is formed adjacent the bottom edge 142 to facilitate insertion into the slot 154.

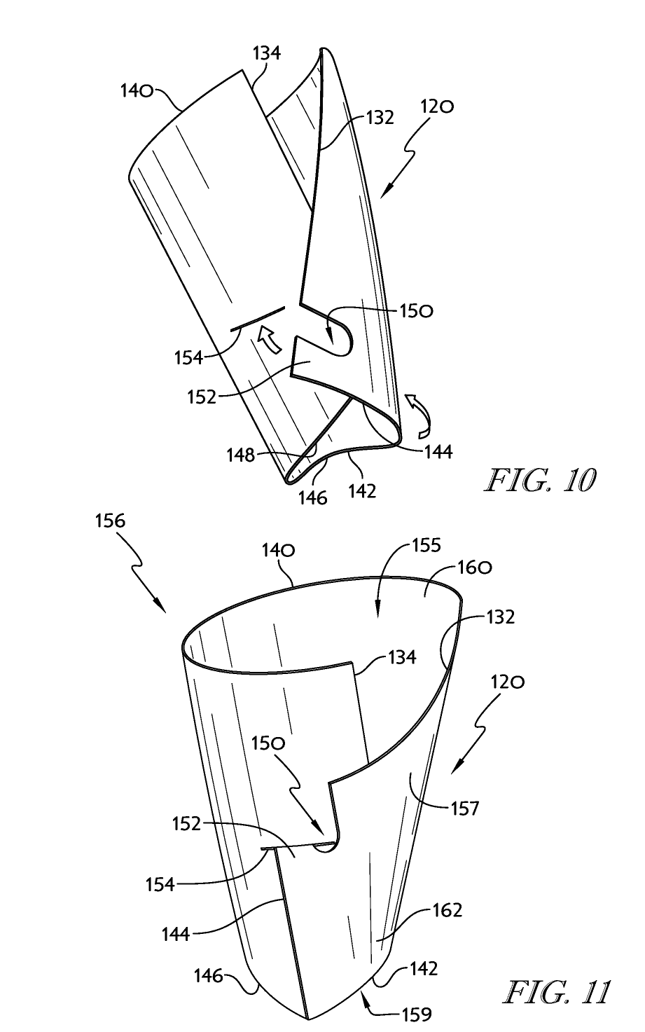

Once the removable label portion 120 is removed from the container 100, a user breaks the perforation line 148 to form an angled slot 154 having the same angle as the angled perforation line 142, as seen in FIGS. 9-11. Optionally, the perforation line 142 may be broken upon removal of the removable label portion 120 from the fixed label 116. Thereafter, the user rolls or manipulates the second side edge 134 toward the first side edge 132 of the removable label portion 120, as seen in FIG. 10, until the tab 152 is adjacent the slot 154. As seen in FIG. 11, the tab 152 is inserted into the slot 154 to retain the removable label portion 120 in a rolled form, which forms the funnel 156. The top edge 140 of the removable label portion 120 forms a top edge or inlet 155 of the funnel 156 through which a fluid may be poured. In the funnel orientation, first side edge 132 also forms portion of the top edge of the funnel 156. In this position, first side edge 132 forms a sloping sidewall portion 157 of the funnel 156.

The bottom edge 142 of the removable label portion 120 forms a bottom edge of the funnel 156, wherein the second, semi-circular segment 146 forms an outlet 159 through which fluid may exit into the container 100. As seen in FIG. 11, a first end 160 of the funnel 156 is wider than a second end 162 of the funnel 156 to facilitate pouring of the fluid into a narrow opening. When removable label portion 120 is rolled into funnel 156, linear segment 144 is generally parallel to second side edge 134.

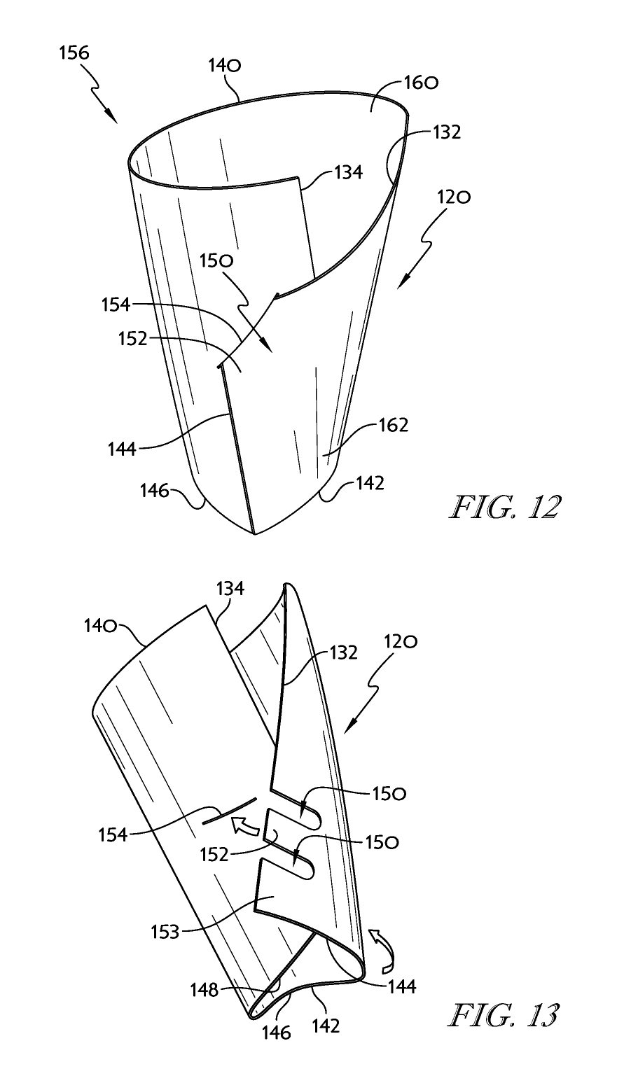

A further illustrative embodiment of a removable label portion 120 is depicted in FIG. 12, in which the removable label portion 120 is similar to the removable label portion 120 of FIGS. 9-11, except that the tab 152 of the embodiment of FIG. 12 is formed by use of a corner of the removable label portion 120. Still another illustrative embodiment of a removable label portion 120 similar to the removable label portion 120 depicted in FIGS. 9-11 is depicted in FIG. 13. The tab 152 of the removable label portion 120 of FIG. 13 is formed by two cutouts 150. In an illustrative embodiment, the cutouts 150 may form a second tab 153 capable of insertion into the slot 154. While a tab and a slot 154 are depicted, the tab 152 may be replaced by a slot or the slot 154 may be replaced by a tab. Optionally, any number of tabs and/or slots may be used or the tab and slot are used in combination with adhesive to form the funnel 156. While specific embodiments of the container 20 are depicted, the present disclosure may be implemented on any container.

The fixed, removable, and retained portions of the labels disclosed herein may be made of any suitable material.

In an illustrative embodiment, the fixed label 116 may be attached to a container using any permanent, semi-permanent adhesive, or combinations thereof. The retained label portions 118a-118c may be attached to the fixed label 116 or directly to the container 100 using any permanent, semi-permanent adhesive, or combinations thereof. The removable label portion 120 may be secured by the perforations 130a, 130b to the retained label portions 118a-118c or attached to the container or the fixed label 116 using a non-permanent adhesive, a pressure sensitive adhesive, a semi-permanent adhesive, or combinations thereof. Any of the adhesives may be water-based, acrylic-based, or rubber.

In another embodiment, the removable label 117 may include retained label portions 118a-118c that are adhered or laminated directly to the container instead of to the fixed label 116. In this embodiment, removable label portion 120 can be separated from the retained label portions 118a-118c to be used as the funnel 156. In this embodiment, removable label portion 120 may or may not include adhesive to secure the removable label portion 120 to the container 100.

Numerous modifications to the present disclosure will be apparent to those skilled in the art in view of the foregoing description. Accordingly, this description is to be construed as illustrative only and is presented for the purpose of enabling those skilled in the art to make and use the peelable label and to teach the best mode of carrying out same.

We claim:

1. A peelable label for a container, comprising:
a fixed label;
a removable label removably attached to at least a portion of the fixed label;
a first securement feature formed along a first side of the removable label; and
a second securement feature formed along a second side of the removable label opposite the first side;
wherein the first and second securement features cooperate to retain the removable label in a shape of a frustoconical funnel.

2. The peelable label of claim 1, wherein the first securement feature is a tab formed by a corner of the removable label adjacent the first side.

3. The peelable label of claim 1, wherein the first securement feature is a tab formed by at least one cutout in the first side of the removable label.

4. The peelable label of claim 3, wherein the second securement feature is in the form of an angled slot that is configured to accept the tab to secure the removable label in the shape of the frustoconical funnel.

5. The peelable label of claim 1, wherein at least a portion of a third side of the removable label extending between the first and second sides has a semi-circular portion that, when the first and second securement features cooperate to form the funnel, forms a circular exit of the funnel.

6. The peelable label of claim 5, wherein a fourth side of the removable label opposite the third side forms an opening of the funnel when the tab is disposed within the slot, wherein the opening is larger than the circular exit.

7. The peelable label of claim 5, wherein the portion of the third side having a semi-circular shape comprises from about 20 to about 50 percent of the third side.

8. The peelable label of claim 5, wherein the third side further includes a linear segment extending between the first side and the semi-circular portion and an angled segment extending between the semi-circular portion and the second side.

9. The peelable label of claim 1, wherein the removable label includes a removable label portion and at least one retained label portion, wherein the retained label portion is attached to the fixed label and connected to the removable label portion by a perforation line.

10. The peelable label of claim 9, wherein removal of the at least one retained label portion from the removable label forms a third side of the removable label portion extending between the first and second sides.

11. The peelable label of claim 10, wherein the removable label includes a second retained label portion that, when removed from the removable label portion, forms a fourth side of the removable label portion opposite the third side.

12. The peelable label of claim 11, further including a third retained label portion that, when detached from the removable label, forms the tab.

13. The peelable label of claim 12, wherein the first, second, and third retained label portions are attached to the fixed label by adhesive.

14. A method of using a peelable label on a container, the method including the steps of:
providing a fixed label disposed on the container;
providing a removable label that is removably attached to at least a portion of the fixed label;
removing at least a portion of the removable label from the fixed label;
manipulating the removable label portion into a frustoconical shape; and
securing a first side of the removable label portion to a second side of the removable label portion opposite the first side to connect the first and second sides and retain the removable label in the frustoconical shape.

15. The method of claim 14, wherein the securing step includes inserting a tab extending from one of the first and second sides of the removable label portion into a slot formed in the removable label portion.

16. The method of claim 14, wherein at least a portion of a third side of the removable label portion extending between the first and second sides is in the shape of a semi-circle that, during the shaping step, forms a first opening through which fluid can exit the funnel.

17. The method of claim 16, further including the steps of placing the opening adjacent a container and pouring a fluid into a second opening of the funnel opposite the first opening.

18. The method of claim 14, wherein the step of removing the removable label portion from the fixed label includes separating the removable label from at least one retained label portion that is attached to the fixed label.

18. The method of claim 17, wherein the separating includes tearing one or more perforations connecting the removable label portion and the at least one retained label portion.

19. A peelable label for a container, comprising:
a fixed label; and
a removable label removably attached to at least a portion of the fixed label and including:
first and second opposing and generally parallel side edges;
a third side edge extending between the first and second side edges, wherein at least a portion of the third side edge has a semi-circular shape that, when the removable label is formed into a shape of a funnel, forms an exit of the funnel; and
a fourth side edge extending between the first and second side edges and opposite the third side edge.

20. The peelable label of claim 20, wherein the portion of the third side edge having a semi-circular shape comprises from about 20 to about 50 percent of the third side edge and the third side edge further includes a linear segment extending between the first side edge and the semi-circular portion and an angled segment extending between the semi-circular portion and the second side edge.

21. A label assembly for a container comprising:
a fixed label having a first side and a second side, the first side adapted to be secured the to the container;
a removable label positioned to overlay at least a portion of the fixed label, the removable label having a removable portion and a retained portion, the retained portion adapted to be secured to the second side of the fixed label and the removable portion is adapted to be secured to the retained portion, the removable portion formed to include a slot;
wherein pulling the removable portion away from the fixed label causes separation of the removable portion from the fixed label and the retained portion; and
wherein the removable portion includes a tab that can be inserted into the slot upon manipulating the removable label portion into a frustoconical shape.

22. The label assembly of claim 21, wherein the removable portion includes a generally linear top edge, first and second side edges and a bottom edge that includes a generally linear segment and a semi-circular segment.

23. The label assembly of claim 22, wherein the semi-circular segment, when the removable portion is formed into a shape of a funnel, forms an exit opening of the funnel.

24. The label assembly of claim 22, wherein removal of the removable portion exposes indicia formed on the second side of the fixed label.

25. The label assembly of claim 24, wherein the removable portion includes indicia that is similar to the indicia formed on the second side of the fixed label.

26. The label of claim 22, wherein when the removable portion is in a frustoconical shape, the linear segment is generally parallel to the second side edge.
